(19) United States
(12) Patent Application Publication
(10) Pub. No.: US 2021/0016624 A1
(43) Pub. Date: Jan. 21, 2021

(54) System And Method For Continuously Monitoring The Ambient Air Of A Motor Vehicle

(71) Applicants: Krystal A. Gilgeours, Hempstead, NY (US); Kelly M. Gilgeours, Hempstead, NY (US)

(72) Inventors: Krystal A. Gilgeours, Hempstead, NY (US); Kelly M. Gilgeours, Hempstead, NY (US)

(21) Appl. No.: 15/018,466

(22) Filed: Feb. 8, 2016

Related U.S. Application Data
(60) Provisional application No. 62/176,105, filed on Feb. 9, 2015.

(51) Int. Cl. B60H 1/00

(52) U.S. Cl. CPC B60H 1/008; B60H 1/00978

(57) ABSTRACT

A method, system and apparatus for detecting dangerous levels of carbon monoxide and alert the occupants of a vehicle is disclosed. In various embodiments, the ambient air gaseous composition detector warns the occupants of the vehicle once the carbon monoxide composition of the vehicle's ambient air reaches a level deemed dangerous. Additionally, the device locates the closest fire department central stations or emergency company stations and sends notifications to the fire department. The device also has a locator service, which directs the emergency responders to the location of the vehicle.

### CROSS REFERENCE TO RELATED APPLICATIONS

This application claims the benefit to U.S. Provisional Application No. 62/176,105, filed on Feb. 9, 2015, which application is incorporated herein by reference as if set forth in its entirety.

### FIELD OF THE INVENTION

The invention relates generally to the detection of ambient air gaseous composition and, more specifically, to the detection of a vehicular ambient air carbon monoxide composition.

### BACKGROUND

The conventional automobile carbon monoxide detector simply detects dangerous levels of carbon monoxide and alerts the occupants of the vehicle. This model leaves it to the occupant or occupants to take corrective action. The model is simple but, leaves much to be desired. It lacks preventive measures in case the occupant is incapacitated or otherwise prevented from taking corrective actions. An alarm is generated upon detection of potentially hazardous concentrations of carbon monoxide. However, if there is no human intervention in a timely manner death can result and often does.

### SUMMARY

Various deficiencies of the prior art are addressed by a system and method for continuously monitoring the carbon monoxide composition of a vehicular ambient air. One embodiment comprises a method for continuously monitoring the carbon monoxide composition of a vehicular ambient air. The method comprises propagating toward one or more I/O components one or more commands structured according to a particular command syntax of said one or more I/O components; obtaining personalized control commands or instructions from an authorized operator of a vehicle; receiving indication of authentication for said authorized operator, said indication being adapted to populate respective topic database; detecting continually a gaseous composition of a vehicular ambient air; and displaying continually carbon monoxide component of the gaseous composition of the vehicular ambient air.

Another embodiment comprises a system for use in continually monitoring the carbon monoxide composition of a vehicular ambient air, the system comprising a carbon monoxide sensor arrangement in communication with a computing apparatus; a plurality of I/O components communicatively coupled to said computing apparatus, wherein the computing apparatus is configured to process data from the carbon monoxide sensor, obtain personalized control commands from an interface module to thereby propagate toward one or more VO components one or more commands structured according to a particular command syntax of said one or more I/O components; an interface means to provide interaction with external and internal peripheral devices; a communication means to provide access to a plurality of networks; and a warning means to provide audible alarms.

### BRIEF DESCRIPTION OF THE DRAWINGS

The teachings of the present invention can be readily understood by considering the following detailed description in conjunction with the accompanying drawings, in which:

FIG. 1 depicts an exemplary vehicular ambient air gaseous composition detector system according to an embodiment;

FIG. 2 depicts an exemplary vehicular ambient air gaseous composition detector automobile view according to an embodiment;

FIG. 3 depicts an exemplary vehicular ambient air gaseous composition detector mandatory installation version according to an embodiment;

FIG. 4A depicts an exemplary vehicular ambient air gaseous composition detector side view according to an embodiment;

FIG. 4B depicts an exemplary vehicular ambient air gaseous composition detector attachment mechanism details according to an embodiment;

FIG. 4C depicts an exemplary vehicular ambient air gaseous composition detector front view according to an embodiment;

FIG. 4D depicts an exemplary vehicular ambient air gaseous composition detector bottom view according to an embodiment;

FIG. 5A depicts an exemplary vehicular ambient air gaseous composition detector back view without stand according to an embodiment;

FIG. 5B depicts an exemplary vehicular ambient air gaseous composition detector back view with stand according to an embodiment;

FIG. 6 depicts an exemplary left-steering wheel vehicular ambient air gaseous composition detector according to an embodiment;

FIG. 7 depicts an exemplary non-traditional vehicular ambient air gaseous composition detector according to an embodiment;

FIG. 8 depicts an exemplary non-traditional vehicular solar-panel powered ambient air gaseous composition detector according to an embodiment;

FIG. 9 depicts an exemplary left-steering wheel vehicular solar-panel powered ambient air gaseous composition detector according to an embodiment;

FIG. 10 depicts an exemplary non-traditional vehicular solar-panel powered ambient air gaseous composition detector according to an embodiment; and

FIG. 11 depicts the flow chart for the exemplary vehicular ambient air gaseous composition detector system of FIG. 1.

To facilitate understanding, identical reference numerals have been used, where possible, to designate identical elements that are common to the Figures.

### DETAILED DESCRIPTION

The invention will be primarily described within the context of particular embodiments; however, those skilled in the art and informed by the teachings herein will realize that the invention is also applicable to other technical areas and/or embodiments.

The illustrative system and method embodiments described herein are not meant to be limiting. It may be readily understood that certain aspects of the disclosed system and methods can be arranged and combined in a variety of different configurations, all of which are contemplated herein.

Generally speaking, the various embodiments enable, support and/or provide a configuration paradigm enabling a motor vehicle equipped with the device to warn the occupants of the vehicle when the level of carbon monoxide within the motor vehicle reaches dangerous levels. Many non-lethal carbon monoxide exposures go unnoticed but may affect an individual's health in ways that may not readily known e.g., brain damage, headaches, confusion, memory loss, nausea, etc. The Centers for Disease Control estimates that carbon monoxide poisoning claims nearly 400 lives, and causes more than 20,000 visits to hospital emergency departments annually.

During 1999-2010, a total of 5,149 deaths from unintentional carbon monoxide poisoning occurred in the United States, an average of 430 deaths per year. The average annual death rate from carbon monoxide poisoning for males (0.22 per 100,000 population) was more than three times higher than that for females (0.07). The death rates were highest among those aged 265 years for males (0.42) and females (0.18). The rates were the lowest for males (0.08) and females (0.04) aged <25 years.

In August 2014, a New Jersey woman died from carbon monoxide poisoning while napping in her car between jobs. This is a most recent though not isolated fatality. This is a situation that could have been avoided if she had woken up in response to an alarm sounding on her phone.

Unintentional, non-fire-related carbon monoxide poisoning is defined both as 1) accidental poisoning by and exposure to gases or vapors (code X47) listed as the underlying cause, and 2) toxic effect of carbon monoxide (code T58) listed as the contributing cause, according to the International Classification of Diseases, 10th Revision. All deaths caused by intentional exposure (X67), exposure of undetermined intent (Y17), or fire-related exposure to carbon monoxide (codes X00-X09, X76, X97, and Y26) were excluded.

Deaths are 12-year annual averages, and death rates are per 100,000 12-year annual average population.

Carbon Monoxide is undetectable by sight or smell (known as a “silent killer”). It is a tasteless, odorless and colorless gas. Carbon Monoxide is the product of combustion of organic matter, which contains carbon, under conditions of restricted oxygen supply. Limited oxygen supply prevents complete oxidation to carbon dioxide.

Mechanism of CO toxicity. Toxicity is a consequence of cellular hypoxia and ischemia. CO binds to hemoglobin with an affinity 250 times that of oxygen, resulting in reduced oxyhemoglobin saturation and decreased blood oxygen-carrying capacity. In addition, the oxyhemoglobin dissociation curve is displaced to the left, impairing oxygen delivery at the tissues.
Clinical Presentation. Symptoms of intoxication are predominantly in organs with high oxygen consumption, such as the brain and heart.
a. The majority of patients describe headache, dizziness, and nausea. Patients with coronary disease may experience angina or myocardial infarction. With more severe exposures, impaired thinking, syncope, coma, convulsions, cardiac arrhythmias, hypotension, and death may occur. Although blood CO-Hgb levels may not correlate reliably with the severity of intoxication, levels greater than 25% are considered significant, and levels greater than 40-50% usually are associated with obvious intoxication.
b. Survivors of serious poisoning may experience numerous overt neurologic sequelae consistent with a hypoxic-ischemic insult, ranging from gross deficits such as Parkinsonism and a persistent vegetative state to subtler personality and memory disorders. Some may have a delayed onset of several hours to days after exposure. Various studies suggest that the incidence of subtle neuropsychiatric sequelae, such as impaired memory and concentration and mood disorders, may be as high as 47%.
c. Exposure during pregnancy may result in fetal demise.
   CO in Special Populations. Children may be more susceptible to the effects of carbon monoxide due to a higher percentage of fetal hemoglobin as well as higher metabolic rates.

Pregnant women should be referred to a hyperbaric center for COHb levels of 15% or greater because fetal morbidity has been demonstrated at lower levels than usual due to the high affinity of carbon monoxide for fetal hemoglobin

The elderly, particularly those with serious comorbid disease, are also at higher risk from carbon monoxide poisoning. In patients with known coronary artery disease, even low levels of COHb (4% to 6%) can cause ECG changes and myocardial ischemia (heart attack).

### Carbon Monoxide Health Effects

Mild carbon monoxide poisoning show symptoms of lightheadedness, confusion and memory loss
More significant carbon monoxide exposures can lead to toxicity of the central nervous system and heart which may lead to death
Carbon monoxide can build up when cars are enclosed in a garage or if the tail pipes are unknowingly obstructed
Exposure at 100 ppm or greater is dangerous to human health
Continuous carbon monoxide exposure may lead to a shorter life span due to heart damage
Carbon Monoxide poisoning in pregnant women may cause severe adverse fetal effects

### Carbon Monoxide Concentration (Ppm=Parts Per Million) and Symptoms

| | |
|---|---|
| 35 ppm (.0035%) | Headache and dizziness within 6-8 hours of |
| | constant exposure |
| 100 ppm (.01%) | Slight headache in 2-3 hours |
| 200 ppm (.02%) | Slight headache within 2-3 hours; loss of |
| | judgment |
| 400 ppm (.04%) | Frontal headache within 1-2 hours |
| 800 ppm (.08%) | Dizziness, nausea and convulsion with 45 mins |
| | insensible within 2 hours |
| 1600 ppm (.16%) | Headaches, Tachycardia, dizziness, and nausea |
| | within 20 minutes; death in less than 2 hours |
| 3200 ppm (.32%) | Headache, dizziness and nausea in 5-10 |
| | minutes. Death within 30 minutes |
| 6400 ppm (.64%) | Headache and dizziness in 1-2 minutes |
| | convulsions, respiratory arrest and death |
| | in less than 20 minutes. |
| 12,800 ppm (1.28%) | Unconscious after 2-3 breaths. Death in |
| | less than 3 minutes |

### Causes and Sources of Carbon Monoxide

| | | |
|---|---|---|
| Average level in homes | 0.5-5 | ppm |
| Natural atmosphere | 0.1 | ppm |
| Exhaust from a home wood fire | 5000 | ppm |
| Undiluted warm car exhaust | 7000 | ppm |

without a catalytic converter

### Common Sources of Carbon Monoxide

cigarette smoke
house fires
faulty furnaces
non electrical heaters
wood burning stoves
internal combustion vehicle exhaust
electrical generators
spray paint
charcoal grills
propane fueled equipment
gasoline powered tools such as leaf blowers and lawn movers.

### RESOURCES

Maloney G. Chapter 217. Carbon Monoxide. In: Tintinalli J E, Stapczynski J, Ma O, Cline D M, Cydulka R K, Meckler G D, T. eds. Tintinalli's Emergency Medicine: A Comprehensive Study Guide. 7e. New York, N.Y.: McGraw-Hill; 2011.
Olson K R. Chapter 44. Carbon Monoxide. In: Olson K R. eds. Poisoning & Drug Overdose, 6e. New York, N.Y.: McGraw-Hill; 2012.

### Websites

http://www cdc.gov/co/
http://www.cdc.gov/mmwr/preview/mmwrhtml/mm6303a6.htm?s_cid=mm6303a6_e
   http://www.nydailynews.com/news/national/new-jersey-woman-worked-multiple-jobs-dies-napping-car-cops-article-1.1920260

The purpose of this product is to detect carbon monoxide levels in any motor vehicle and to alert the user in every way possible. The salient features of device are:

1. A touched screen surface with personalization (easy to set up, 1-2-3 set up)
2. Sends notifications to fire alarm central stations or emergency company stations. The device has a locator service (and tells the emergency respondents where to go) so that the location of the vehicle is known. Also included is a function that locates the closest fire department and contacts them for you.
3. The device beeps and/or A voice mentions levels is high/dangerous levels approaching (similar to Siri for the iPhone) (in worldwide different languages) and lights up as well as sending notifications to smart devices when carbon monoxide dangerous levels are reached in vehicular so correct emergency action takes place so occupants of the vehicular can be safe.
4. When carbon monoxide levels reach dangerous levels, the device regulates the air to normal condition. (Filters the air)
5. Should be mandated as essential part of a vehicle, fixed safety device, such as the seatbelt.
6. Has the time on visual screen or personalized screen saver that can be uploaded from company website.
7. Has a log history database of previous carbon monoxide incidents. (most likely it would be part of smart device application/program).
8. Mandatory program/application for all future smart devices
9. Linked to any phone/smart device through Bluetooth/any type of wireless connection so that the user can monitor carbon monoxide levels on the phone/smart devices (laptop/tablet/tv/etc.).
10. Using the solar panels and battery back-up, the device still operates even power is turned-off. Stated differently, the device will wake-up if either of two power sources are in place, namely solar panel is connected to the device or batteries are installed. As such, the presence of dangerous level of carbon monoxide will trigger this wake-up function.

It will be appreciated that functions depicted and described herein may be implemented in software and/or hardware, e.g., using a general purpose computer, one or more application specific integrated circuits (ASIC), and/or any other hardware equivalents.

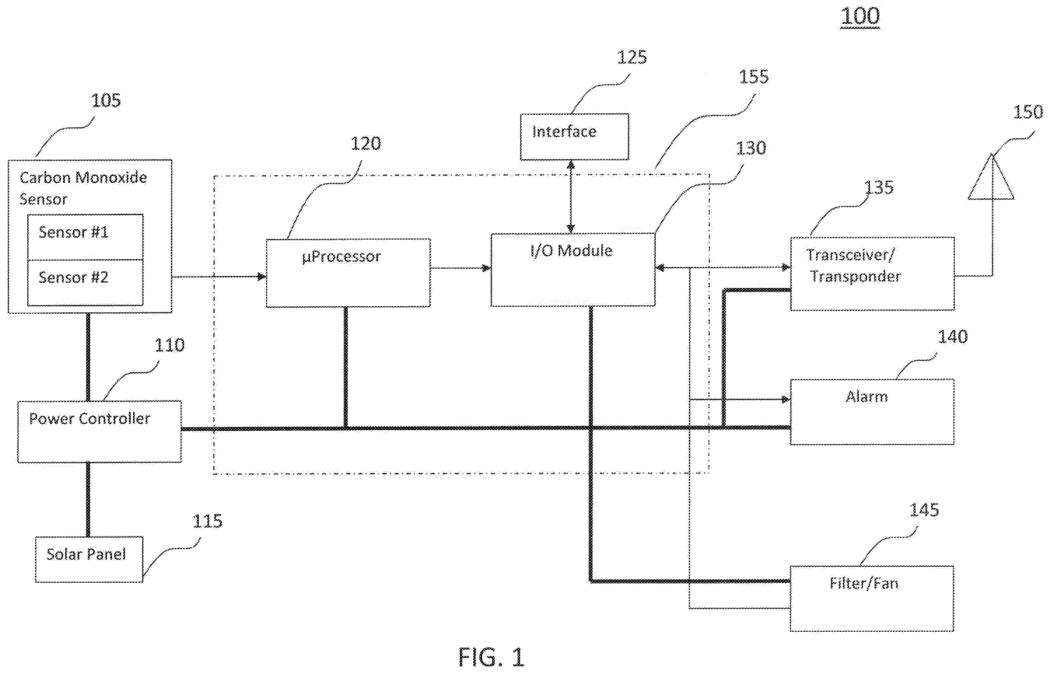

FIG. 1 depicts an exemplary vehicular ambient air gaseous composition detector system according to an embodiment. As depicted in FIG. 1, device 100 comprises carbon monoxide sensor 105 communicatively coupled to computing device 155. It will be appreciated that computing device 155 provides a general architecture and functionality suitable for implementing functional elements described herein and/or portions of functional elements described herein. Computing device 155 may include one or more elements in addition to or instead of those shown.

In one embodiment, carbon monoxide sensor 105 comprises one sensor. In another embodiment, carbon monoxide sensor 105 comprises more than one sensor in parallel arrangement thereby providing dual redundancy. In another embodiment, carbon monoxide sensor 105 comprises more than one sensor in a series arrangement thereby providing impedance matching capability. Based on the particular sensor's signature (e.g., response time, set-up time and the like) used, it may be necessary to implement an interface protocol to thereby insure proper operation of the sensor system. For example, in one embodiment the interface protocol is implemented in hardware. In another embodiment, the interface protocol is implemented in firmware. In yet another embodiment, the interface protocol is implemented in software. Finally, a combination of the foregoing embodiments may be necessary. When carbon monoxide levels get dangerous, a text message is sent to the user's smart device phone number, which was entered from display 205.

Power controller 110 provides power to device 100 including carbon monoxide sensor 105 and computing device 155. As such, the power supply may include, for example backup batteries. Other power supply configurations are possible as well. The long-duration battery keeps the system going. Using solar panels 115 and battery back-up, the device still operates even if power is turned-off. Stated differently, the device will wake-up if either of two power sources are in place, namely solar panel 115 is connected to the device or batteries are installed. As such, the presence of dangerous level of carbon monoxide will trigger this wake-up function.

Processor 120 included in computing device 155 may comprise one or more general-purpose processors and/or one or more special-purpose processors (e.g., image processor, digital signal processor, vector processor, etc.). To the extent that computing device 155 includes more than one processor, such processors could work separately or in combination. Computing device 155 may be configured to control functions of system 100 based on input received from carbon monoxide sensor 105, interface 125 or transponder/transceiver 135 via wireless/IP/RF communication antenna 150, for example. While processors are generally discussed within the context of the description, the use of any device having similar functionality is considered to be within the scope of the present embodiments. Computing device 155 generally includes a central processing unit (CPU) connected by a bus to memory and storage (not shown).

I/O module 130 comprises one or more volatile and/or nonvolatile storage components such as optical, magnetic, and/or organic storage and I/O module 130 may be integrated in whole or in part with computing device 155. Memory portion of I/O module 130 such as EEPROM may contain instructions (e.g., applications programming interface (API), configuration data, host suite, middleware suite) executed by processor 120 in performing various functions of system 100, including any of the functions or methods described herein. I/O module 130 may further include instructions executable by processor 120 to control and/or communicate with the additional components of device 100. These APIs are also used in various embodiments for transferring data from Interface 125 to Computing device 155. Although depicted and described with respect to the aforementioned APIs, it will be appreciated by those skilled in the art that other APIs having similar functionality are considered to be within the scope of the present embodiments.

Interface 125 comprises both user interface and external interface. In one embodiment, the user interface includes a touch screen display 205. The touch screen display is used as an interactive environment for the user and displays in different colors of all the parts that are used in device 100. In one embodiment, interface 125 allows the user to upload a picture as a background with a built in SD card slot on device 100. There are four libraries that are included to access the functions that are needed to communicate with the display. They are included by:

#include <SPI.h>
#include “Adafruit_GFX.h”
#include “Adafruit_HX8357.h”
#indude “TouchScreen.h”

The functions that are used to write to the display come from the Adafruit_HX8357 library and the functions that communicate with the touchscreen portion of the product come from the touchscreen library. Furthermore to write to the display tft is used and to use the touchscreen portion p is used. Example below:

Adafruit_HX8357 tft = Adafruit_HX8357(TFT_CS, TFT_DC, TFT_RST);
TSPoint p = ts.getPoint( );

The seven functions that is used for writing to the display are fillScreen( ), setCursor( ), setTextColor( ), setTextSize( ), print( ), drawCircle( ), and drawRect( ). When you write to the display you have to give the x-coordinates and y-coordinates of where on the display you want to write to. Writing to the display is writing to a map. The specific coordinates of where a point on the screen is needs to be defined. Also, every time the screen needs to be refreshed and there is something new to write on, we have to use the filllScreen( ) function. To show how all of this works, an example to write a line of code is shown below:

tft.setCursor(45, 235);
tft.setTextColor(HX8357_RED);
tft.setTextSize(1);
tft.print(“Data”);

The setCursor( ) function sets up the x-coordinates and y-coordinates of where the text is going to be put on the screen. The setTextColor( ) function sets the color of what the text should be. The setTextSize( ) function determines how big or small the text should be. Finally, the print( ) function prints out the line of text onto the screen of what we choose. The drawCircle( ) and drawRect( ) functions are in the following format:

drawCircle(int x_axis, int y_axis, uint8_t radius, uint16_t color)
drawRect(int16_t x, int16_t y, int16_t w, int16_t h, uint16_t color)

This is a similar format of how the text was displayed in that the coordinates of where the object is displayed on the screen is defined, but the difference is the size of a circle is determined by its radius and for the rectangle the size is determined by width and height. To interact with the touch screen, the x( ) and y( ) functions are used which determine the x-coordinates and y-coordinates on the display. Example below:

if( ((p.x > 20)&&(p.x < 70)) && ((p.y > 220)&&(p.y < 300)) )
{
data _menu( );
}

In these lines of code, if where is pressed on the screen is between the coordinates listed, then the data_menu( ) function will execute.

The user has an option to upload an image to be used as a background image. When the file is read in, the data is parsed in the function bmpDraw (char *filename, uint8_t x, uint16_t y). This function is called every time the display is updated. The filename is updated through a picture buffer array in the background menu.

It will be appreciated that above described algorithm may be implemented differently by an artisan of ordinary skill in the art.

The user can also monitor the carbon monoxide levels over any period of time on the display.

The external internal portion of interface 125 comprises an option to plug external devices in through a USB host. A chip acts as a USB host controller and is connected to computing device 155. HID devices such as a keyboard can be connected. If the user wishes to use an external keyboard instead of the virtual keyboard, it can be connected to the USB host. The keyboard can navigate through a screen by using the up, down, left, and right arrows. Data is entered with the enter key. The characters and numbers of the external keyboard can be used to replace the ones of the virtual keyboard. In another embodiment, the vehicle on board computer system can communicate with device 100 using interface 125.

In one embodiment, text messages and phone calls are made possible via Transceiver/Transponder 135 using the corresponding chip, e.g., SIM900 an activated SIM card, and antenna 150. The carbon monoxide level will be included in the text message that is sent as well as the GPS coordinates of the device in latitude and longitude coordinates.

### GSM/GPRS:

GPRS (Global Packet Radio Service) works by using the idle radio capacity created by the (Global System for Mobile Communications) GSM cellular network, which is the capacity of a network provider that is not being used. A GPRS module sends data transmission through data packets through multiple paths across a GSM network. The texting and calling function of device 100 works through the GSM cellular network and is controlled by AT commands. Those AT commands is the data transmission that GPRS module sends. In one embodiment, the GPRS module in is a SIM900 chip. Other chips having similar functionality may be used. The SIM900 chip communicates to processor 120 through dedicated pins, which act as a software serial port, also known as a UART. Communication to the cellular network is made possible with the combination of the SIM900 chip and a PCB antenna with an IPEX connector. Because SIM900 is used as a software serial port, the library for software serial can be included by the beginning of the program using the line of code:

#include <SoftwareSerial.h>
and by declaring: SoftwareSerial gsmSeial(7,8); This allows the use of the class SoftwareSerial by using gsmSerial. In doing this, the functions from the library SoftwareSerial can be accessed within that class. Communication to the chip is achieved by using the functions print and printIn. There are built-in commands that communicate over the GSM network and those are AT commands. The two commands that used for device 100 are those for sending a text message and making a phone call. To send a text message, SMS mode is entered by the command “AT+CMGF=1/r” to send a message to a specific phone number “AT+CMGS=\“+18888888888””. The number provided is used as an example. To make a phone call is similar and is done by “ATD+18888888888”. To send a text message and to make a phone call are used as two separate functions void SendTextMessage( ) and void DialVoiceCall( ). Example code of how SendTextMessage is implemented and shown below.

gsmSerial.printIn(“AT+CMGF=1\r”); //Set the shied to SMS mode
gsmSerial.printIn(“AT+CMGS =\“+18888888888\””); //Sample phone
number
gsmSerial.printIn(“Caution! The Carbon Monoxide levels in your car are
too high!”);
gsmSerial.print(“Carbon monoxide level is: ”);
gsmSerial.print(sensorValue);
gsmSerial.printin(“PPM”);
gsmSerial.print(“The GPS coordinates of your sensor are: ”);
gsmSerial.print(GPS.latitude);
gsmSerial.print(“,”);
gsmSerial.printIn(GPS.longitude);

### GPS:

GPS (Global Positioning Satellite) works by GPS receivers using a constellation of satellites and ground stations to compute position and time almost anywhere on earth. There are ground based stations that communicate with the satellite network and are called the control segment. Common systems that are used by the control segment are WAAS (Wide Area Augmentation System) and DGPS (Differential Global Positioning Satellite). WAAS is the most common system and improves accuracy to about 5 meters. On the other hand, DGPS gets centimeter accuracy but is more expensive. GPS data is displayed in different message formats and the type of data that is outputted is NMEA (National Marine Electronics Association) data. In one embodiment, the GPS portion of device 100 can track up to 22 satellites on 66 channels. An external UFL antenna 150 is connected to the GPS module. The library with the functions that is used can be attached in the program by:
#include “Adafruit_GPS.h”

To initialize the GPS and to begin tracking the longitude and latitude, in the setup the following lines of code is executed:

GPS.begin(9600); // sets up the baud rate for the chip
GPS.sendCommand(PMTK_SET_NMEA_OUTPUT_RMCGGA); // gives a minimum and fixed data
GPS.sendCommand(PMTK_SET_NMEA_UPDATE_1HZ); // 1 Hz update rate
GPS.sendCommand(PGCMD_ANTENNA); // Gets updates on antenna useInterrupt(true); // sets interrupt that continuously checks for data
A timer interrupt is used every millisecond to check for updated data. The functions that will be used to track device 100 are latitude( ) and longitude( ). In the program, to use these values they are placed in the function GPS_Coordinates( ). This function is called in the data function and an example of how it is implemented is shown below:
gprsSerial.print(GPS.latitude);
gprsSerial.print(“ ”);
gprsSerial.printIn(GPS.longitude);

In the user interface part of the electronic, the user can upload a picture as a background with a built in SD card slot on the electronic. The user can also monitor the carbon monoxide levels over any period of time on the display. This is made possible with a real time clock.

In one embodiment, computing device 155 interacts with GPS based networks and Cellular based network via link 150. In one embodiment, link 150 extends over great distance and is a cable, satellite or fiber optic link, a combination of such links or any other suitable communications path. In other embodiments, link 150 extends over a short distance. In other embodiments, link 150 may be a local area network, or may be network connections between geographically distributed systems, including network connection over the Internet. In other embodiments, link 150 is wireless. Yet, in other embodiments link 150 may be an access network, a virtual private network. In other embodiments, link 150 is any communication network, the Internet, the Cloud and other networks having similar functionality and is therefore considered to be within the scope of the present embodiments.

Alarm 140 is used to send audible warning when the carbon monoxide levels get dangerous. In one embodiment, if the user indicates the presence of small children or pregnant women in the vehicle, the alarm level is adjusted accordingly. A text message is sent to the user's smart device phone number, which was entered from the display. In another embodiment, text messages are sent to additional destinations.

Filter/Fan 145 are also activated along with the audible alarm when the carbon monoxide levels get dangerous. In one embodiment, filter/fan 145 is external to the vehicle. In another embodiment, the internal ventilation system of the vehicle is used.

In one embodiment, the closest fire department is located and alerted. In another embodiment, other first aid responders are located and compared against the location of the closest fire department.

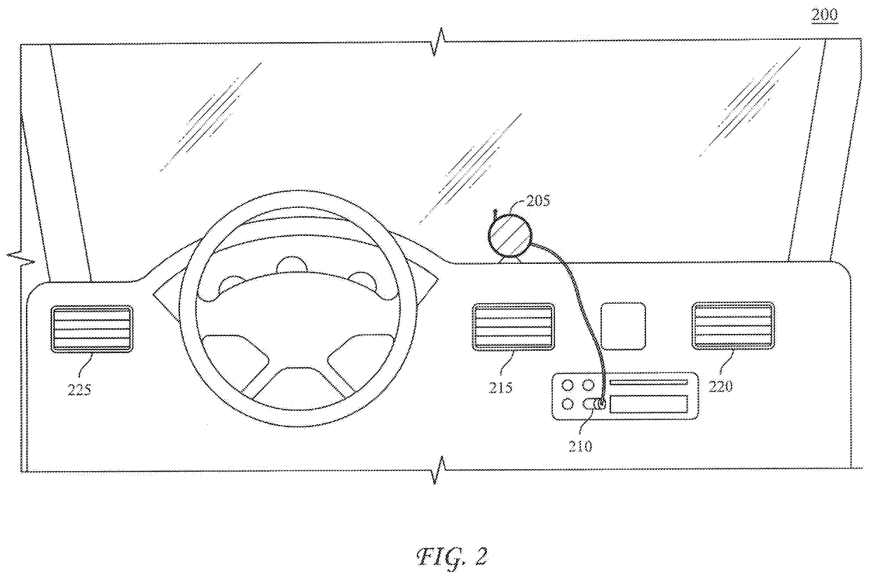

FIG. 2 depicts an exemplary vehicular ambient air gaseous composition detector automobile view according to an embodiment. As shown, device 205 is placed on the dashboard of the vehicle. It is recommended that device 205 be placed so not to obstruct the driver's view or in any way impede the safety of the passengers. Device 205 uses the car power outlet 210. Air vents 215, 220 and 225 are activated when the vehicle's internal ventilation system is used.

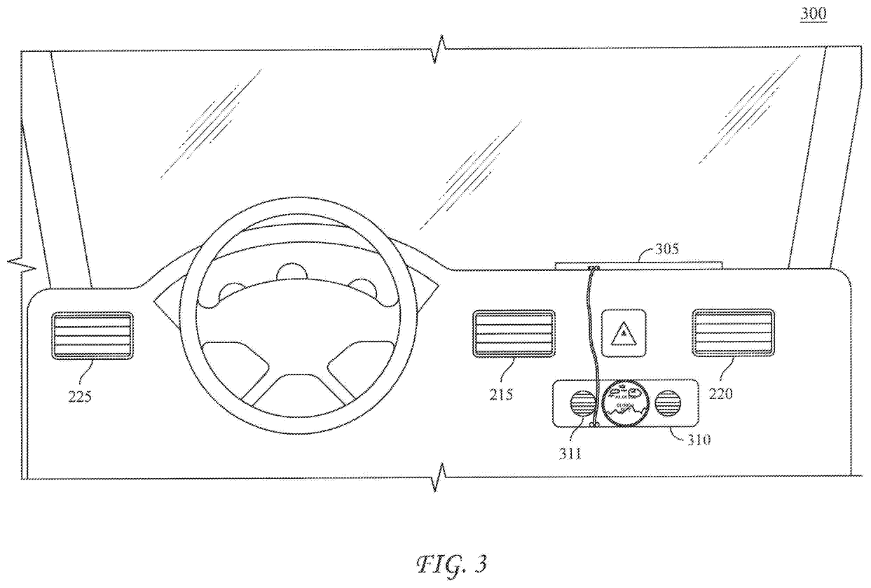

FIG. 3 depicts an exemplary vehicular ambient air gaseous composition detector mandatory installation version according to an embodiment. In this embodiment, solar panel 305 is used as a secondary power supply and air vents 310 and 311 are used for filtration purposes. In one embodiment, the internal vehicular ventilation system is used in addition to the device's filtration system. In another embodiment, the device's filtration system is used as back-up to the vehicle's ventilation system. For example, if the vehicle's battery is dead. In one embodiment, the vehicle's sound system is used to warn the occupants of the vehicle.

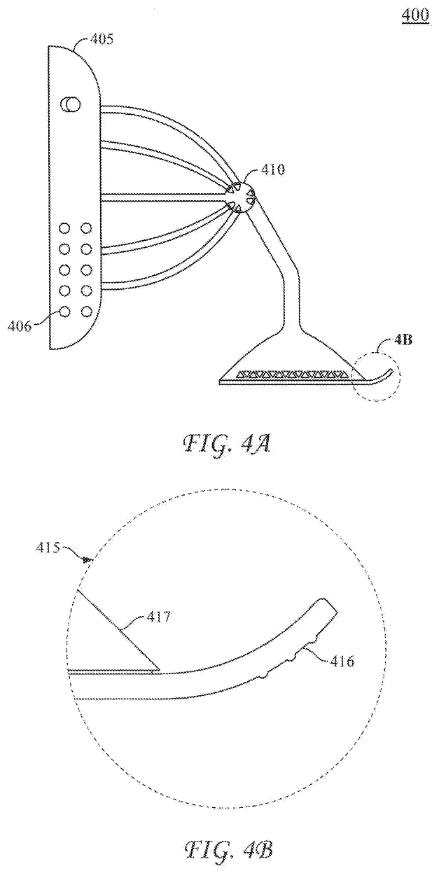

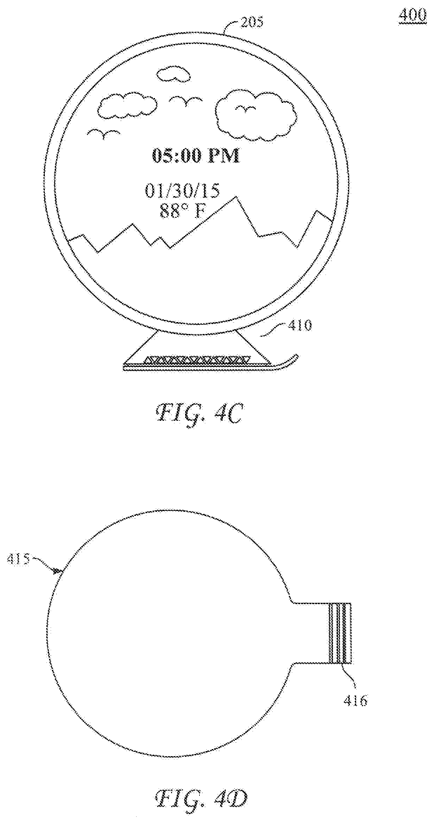

FIG. 4A depicts an exemplary vehicular ambient air gaseous composition detector side view according to an embodiment. In this embodiment, device 100 is shown housed in enclosure 405. Device 100 is placed on a mounting surface by applying pressure on 417. As shown in FIG. 4B, 416 provides suction enabled by finger grips shown adjacent to 416 in FIG. 4D. Device 100 is released by pulling 416 to release suction. Device 100 is adjusted using mechanism 410.

FIG. 4C depicts an exemplary vehicular ambient air gaseous composition detector front view according to an embodiment. In this embodiment, display 205 is shown. In one embodiment, display 205 is a touch screen display. In another embodiment, display 205 is a traditional display.

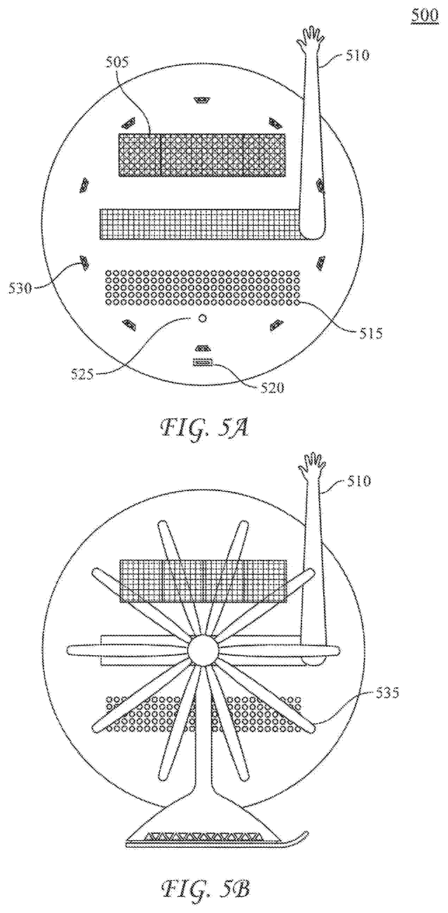

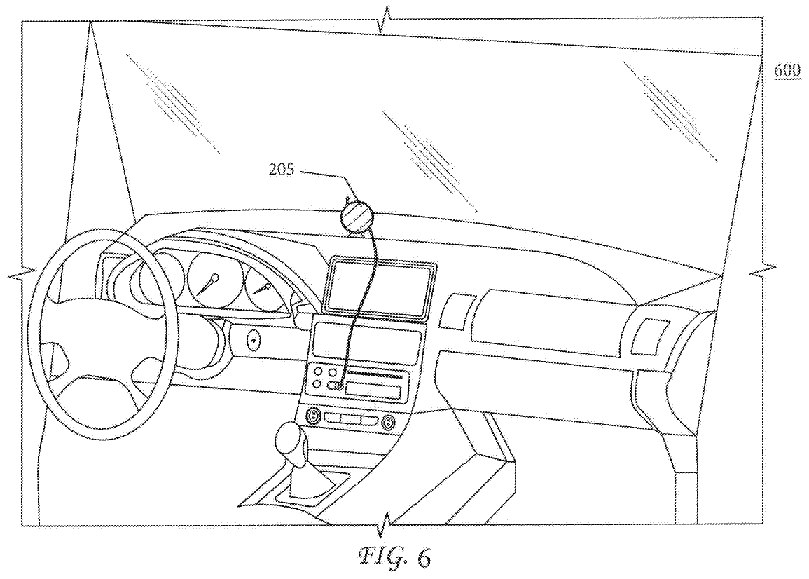

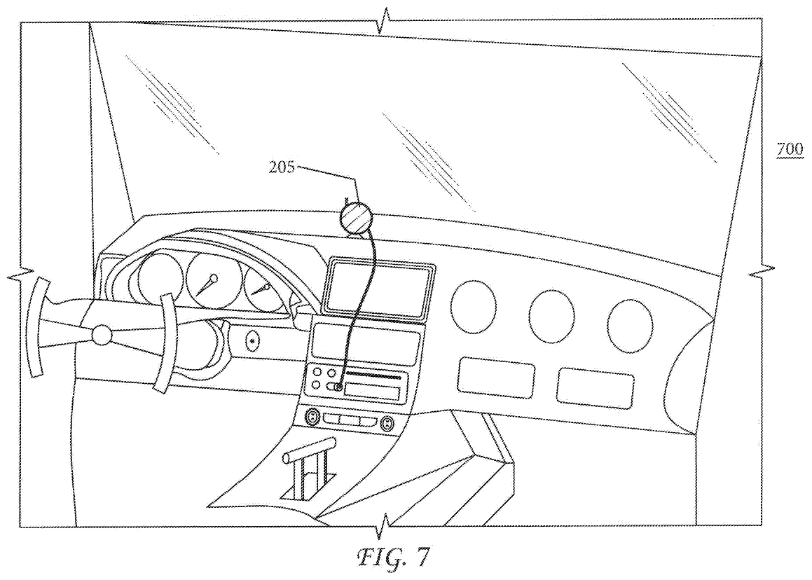

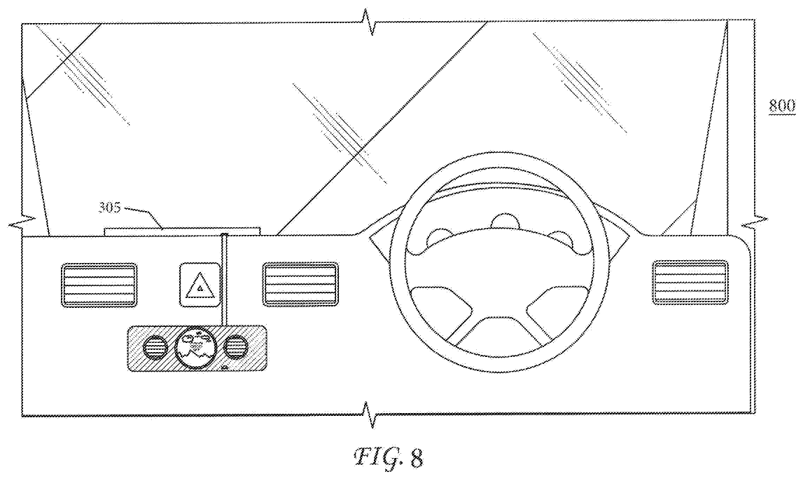

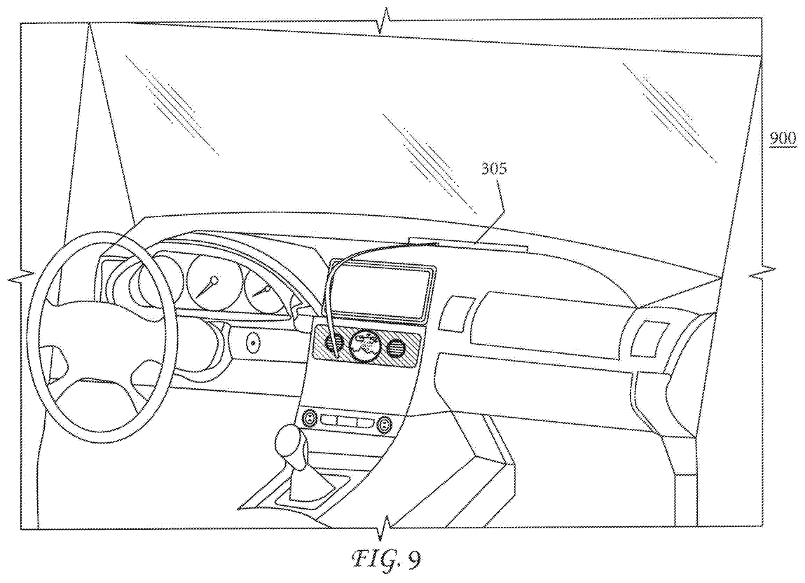

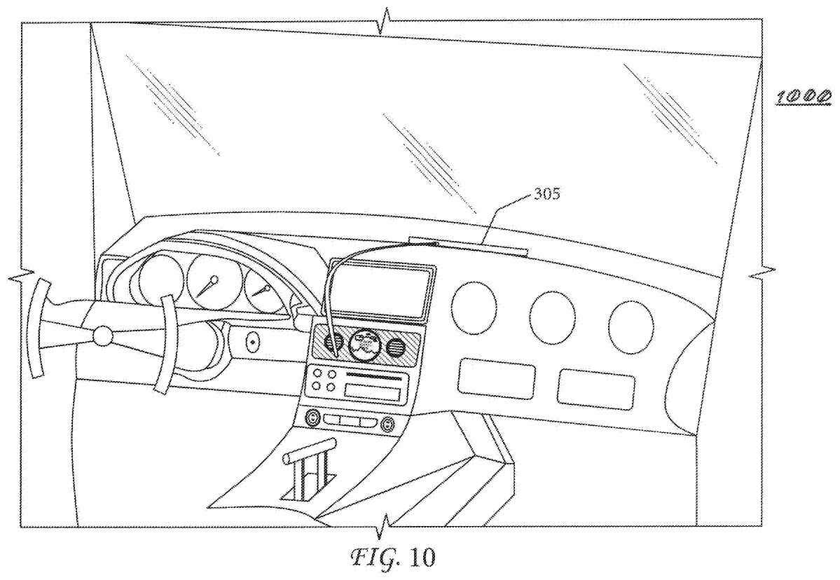

FIG. 5A depicts an exemplary vehicular ambient air gaseous composition detector back view without stand according to an embodiment. In this embodiment, device 100 rear view is shown with solar panel 505, latch for stand connections 530, reset button 525, charger interface 520 and sound apparatus 515.

FIG. 5B depicts an exemplary vehicular ambient air gaseous composition detector back view with stand according to an embodiment. In this embodiment, device 100 rear view is shown with antenna 510 and support mechanism 535.

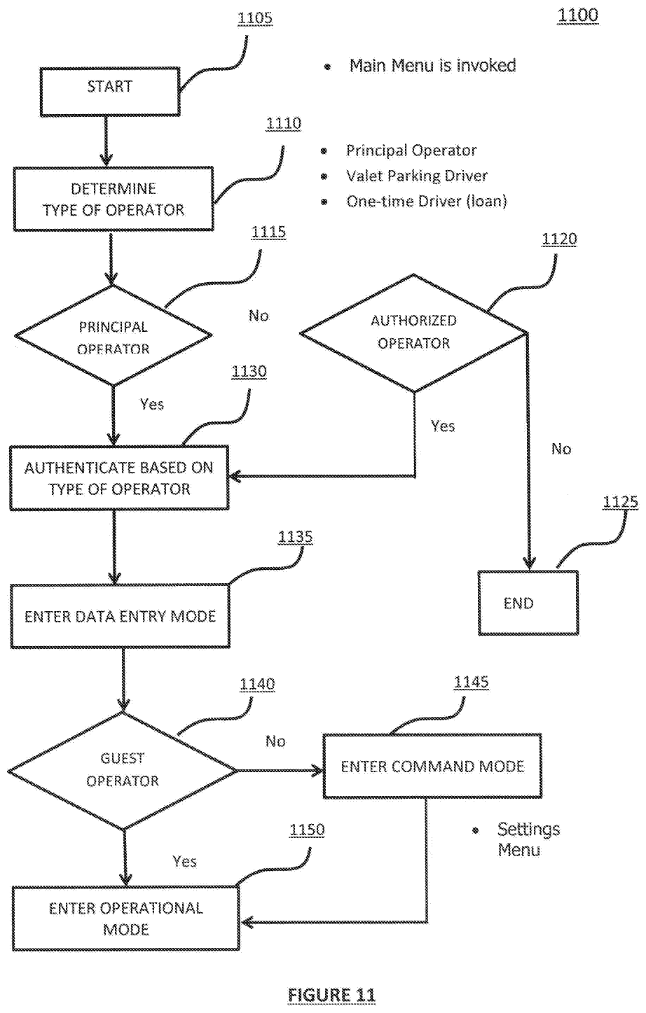

FIG. 11 depicts the flow chart for the exemplary vehicular ambient air gaseous composition detector system of FIG. 1.

Various embodiments operate to provide the functions of device 100 that can be tuned to achieve some of the above outlined objectives without sacrificing others.

At step 1105, device 100 is turned on using a power switch. In another embodiment, device 100 is turned on in conjunction with the particular vehicle. Once the device is on, the main menu is invoked. There are 5 options that can be accessed namely, Data, Volume Control, Brightness, Background and Settings. In another embodiment, other options are provided.

### Data Menu:

The data menu has a graphical view on the display, but also does a lot within the code. The data menu shows the carbon monoxide values from the gas sensor over a period of time. This is made possible by a real time clock. The functions to control the real time chip is obtained by including the library shown below:

#include “RTClib.h”
#include <Wire.h>

The functions are accessed by using RTC. Example shown below:

### RTC_DS1307 RTC;

To get current time, day, month, and year, the following functions can be used respectively: now, day( ), month( ), and year( ). To get a more precise time in seconds over an extended period of time over the future or past now.unixtime( ) is used. From this function, a bar graph of sensor data over various periods of time can be created. The default setting is an hour and when the sensor data gets smaller or larger, the height of the rectangle decreases or increases. The user can select to see this sensor data bar graph for an hour, day, week, month, or year by click the option which is text in a rectangle at a certain position in the display.
Now in code in this data_menu( ) function, which is the function that incorporates everything for data menu. If the sensor data reaches a dangerous level, a text message is sent to the user and a piezo buzzer is turned on to alert that there is dangerous carbon monoxide levels. The carbon monoxide level and GPS coordinates are sent to the user and any emergency contacts in the text message. If the carbon monoxide level is raised to a very dangerous level, the authorities will be alerted with a phone call by the DialVoiceCall( ) function.

### Volume and Brightness Menu:

The volume menu and brightness menu are two separate menus, but they are setup very similarly. The user has the option to pick 1 through 8, 1 being the smallest and eight being the largest. The sound in this device comes from a piezo buzzer and the lower the frequency, the lower the sound and the higher the frequency, the higher sound.

### Background Menu:

In the background menu, the user has the option of setting up a picture as a background on the display. The file that holds the picture is read from an SD card attached to the display. The file that is being read is a bmp file, so the user needs to enter in the file of the picture in the correct format. A virtual keyboard on the display is created and consists of a square representing each letter and number. This is done using the drawRect( ) function. When each key is pressed, it is stored as a variable in an array. The array is what is used as the filename in the bmpDraw( ) function. This is used every time the display is being updated.

### Settings:

The settings menu provides the user with the option of changing certain user preferences. When each of these functions is activated, the virtual keyboard is used, but an array is filled for each option. Once the array changes, which will happen each time the user updates the setting, it changes where it is used in the program, such as a phone number being used to send text messages.

At step 1110, the type of operator is determined by prompting the user to provide relevant credentials. For example, the type of operator can be the owner of the car, i.e., principal operator or a valet parking driver. The car can be on loan. If it's not the principal operator, step 1120 is executed. At step 1120, it's determined if the operator is authorized. The authentication request includes one or more random numbers of Diffie-Hellman key exchange. If the operator is unauthorized, step 1125 is executed and the device is not operational. In one embodiment, if more than attempts are made, the alarm mode is activated.

If the operator is authorized, step 1135 is executed. A screen appears prompting the user to either be a guest or to sign in as principal. In one embodiment, if the user is determined to be an authorized guest, then the user is prompted to enter a name, email, contact info, and emergency contact info with the virtual keyboard. The information entered will be static meaning when the user turns off the device and turns it back on, the information will disappear and will have to re-login as a guest. Then, step 1150 is executed where the device enters the operational mode.

In one embodiment, if the user is authenticated as the principal driver step 1145 is executed where the device enters the command mode. In this mode, the user has the option to change the settings as outlined above. Next, step 1150 is executed where the device enters the operational mode.

In another embodiment, if the user is a principal, then a screen will appear having the user enter a usemame, password, name, email, contact info, and an emergency contact info. Now, the information will be saved and when the electronic is turned off and turned back on, there will be an option to click on the newly entered usemame as a new user profile. Although primarily depicted and described herein with respect to the above-mentioned embodiments, it will be appreciated that the algorithm may be used in other embodiments.

Although various embodiments which incorporate the teachings of the present invention have been shown and described in detail herein, those skilled in the art can readily devise many other varied embodiments that still incorporate these teachings.

It is contemplated that some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in fixed or removable media, and/or stored within a memory within a computing device operating according to the instructions.

What is claimed is:

1. A method for continuously monitoring the carbon monoxide composition of a vehicular ambient air, comprising:
propagating toward one or more I/O components one or more commands structured according to a particular command syntax of said one or more I/O components;
obtaining personalized control commands or instructions from an authorized operator of a vehicle;
receiving indication of authentication for said authorized operator, said indication being adapted to populate respective topic database;
detecting continually a gaseous composition of a vehicular ambient air; and
displaying continually carbon monoxide component of the gaseous composition of the vehicular ambient air.

2. The method of claim 1, wherein the authorized operator is the owner of the vehicle.

3. The method of claim 2, wherein the owner of the vehicle is the principal operator.

4. The method of claim 2, wherein the owner of the vehicle is the authorized operator is a guest.

5. The method of claim 1, wherein the authentication request includes one or more random numbers of Diffie-Hellman key exchange.

6. A system for use in continually monitoring the carbon monoxide composition of a vehicular ambient air, comprising:
a carbon monoxide sensor arrangement in communication with a computing apparatus;
a plurality of I/O components communicatively coupled to said computing apparatus;
a memory having stored thereon instructions that upon execution by the computing apparatus cause the computing apparatus to process data from the carbon monoxide sensor arrangement, detect continually a gaseous composition of a vehicular ambient air, display continually carbon monoxide component of the gaseous composition of the vehicular ambient air, obtain personalized control commands from an interface module to thereby propagate toward one or more I/O components one or more commands structured according to a particular command syntax of said one or more I/O components;
an interface means to provide interaction with external and internal peripheral devices;
a communication means to provide access to a plurality of networks; and
a warning means to provide audible alarms.

7. The system of claim 6, wherein carbon monoxide sensor arrangement comprises dual redundant sensors.

8. The system of claim 7, said dual redundant sensors are in parallel.

9. The system of claim 6, wherein the carbon monoxide sensor arrangement comprises sensors in series.

10. The system of claim 6, wherein the communication means communicates personalized data to first responders.

11. The system of claim 10, wherein said first responders include fire, police and Emergency Medical Service (EMS).

12. An apparatus for hosting a carbon monoxide application over a network, comprising:
a processor adapted to perform a plurality of host functions using a carbon monoxide middleware suite and a carbon monoxide host suite;
the carbon monoxide middleware suite enabling communications with one or more first responders;
the carbon monoxide host suite enabling communications with other carrier host suites to thereby implement the carbon monoxide application.
